(19) United States
(12) Patent Application Publication
(10) Pub. No.: US 2007/0202723 A1
(43) Pub. Date: Aug. 30, 2007

(54) Light emitting assembly for a non-rigid substrate

(75) Inventor: Christopher Varrin, Monte Sereno, CA (US)

Correspondence Address: OSHA LIANG L.L.P., 1221 MCKINNEY STREET, SUITE 2800, HOUSTON, TX, 77010, US

(73) Assignee: Element Labs, Inc., Santa Clara, CA (US)

(21) Appl. No.: 11/704,739

(22) Filed: Feb. 9, 2007

Related U.S. Application Data
(60) Provisional application No. 60/771,672, filed on Feb. 9, 2006.

(51) Int. Cl. H01R 13/62

(52) U.S. Cl. 439/157

(57) ABSTRACT

A light emitting assembly, a light emitting system, and a method of securing a light emitting assembly to a substrate are disclosed. The light emitting assembly includes a male member with a pixel coupled thereto engaging a female member, in which the pixel is viewable through the female member. The assembly secures to a substrate and the pixel is configured to receive an electrical signal and power. The display system includes a plurality of the light emitting assemblies secured to a substrate and configured to receive electrical signals and power. The method includes providing a male member with a pixel coupled thereto and a female member. A substrate is disposed between the members, and the members are then engaged with one another to secure the substrate therebetween.

### CROSS-REFERENCE TO RELATED APPLICATIONS

This application claims benefit of U.S. Provisional Application Ser. No. 60/771,672 filed on Feb. 9, 2006 and entitled “Flexible Display Unit” in the name of Chris Varrin.

### BACKGROUND OF INVENTION

1. Field of the Invention

Embodiments disclosed herein generally relate to light emitting assemblies and systems. Specifically, selected embodiments relate to an improved light emitting assembly with pixels for use in various industries.

2. Background Art

Light emitting assemblies for entertainment, architectural, and advertising purposes have commonly been constructed using multiple pixels, such as light emitting diodes (LEDs) or incandescent lamps mounted onto flat panels. These pixels may be selectively turned on and off to create patterns, graphics, and video displays for both informational and visual purposes. It is well known in the art to construct these assemblies and displays from tiles or large panels, each tile or panel possibly containing several pixels. These tiles or panels may then be assembled in position for an entertainment show or event, or as an architectural or advertising display. Examples of such systems are disclosed in U.S. Pat. Nos. 6,737,983 and 6,677,918.

Increasingly, light emitting assemblies are being used on the exteriors of buildings for entertainment, architectural, or advertising purposes in a manner that does not fully integrate them into the style and physical envelope of the building. As this light emitting assembly market expands into new domains, the classic fixed structure of the assembly becomes a limitation. For example, Times Square in New York City and the Las Vegas Strip are two areas littered with such light emitting assemblies either contained within the wall of glass buildings or grafted onto the outside of buildings with little regard for the buildings' architecture. These types of light emitting assemblies face limits on transparency, weight, and how they are integrated with the architecture.

As this practice continues, it may be useful to incorporate the light emitting assemblies into the actual skin of the building. One technique of doing so is to combine the cladding system (e.g., a stainless steel or aluminum cladding system) with a light emitting assembly. The light emitting assembly could be a standard matrix type with the LED clusters mounted in holes or mounted on the exterior. U.S. Pat. No. 6,237,918 discloses such a system, effectively integrating the electronic and structural components of a light emitting assembly into the outer structure of a building. In this system, the LED beams forming a matrix of pixels are incorporated into a void in the glass wall of the building. However, this type of system has several limitations preventing full architectural usefulness of the light emitting assemblies. Such a system may be difficult to maintain because of its inaccessibility. Further, even when the system could be used to back light a graphic on the glass exterior, issues with line of sight would prevent the LED system from acting as a part of the graphic because the alignment of the two would shift as the viewer moves.

Further, many light emitting assemblies now may use the word “curtain” to soften the public impression that LED displays are all composed of large metal boxes. However, several products that claim to be curtains do not function in such a way as the description would suggest. Prior art curtains may still be rigid in structure and not practical in use as a theatrical backdrop, such as a screen or fabric released from a box or sling and falls freely. However, through recent innovation, there are some designs and existing products that do incorporate flexible structures to function as a fabric or as a traditional curtain. Examples of such systems are disclosed in U.S. Pat. Nos. 5,900,850 and 6,362,801, in addition to U.K. Published Patent Applications GB 2 277 797 A and GB 2 330 196 A. Further, in addition to applications as curtains and backdrops, light emitting assemblies in the prior art are used in other flexible structures, such as within clothing. Examples of these applications are disclosed in U.S. Pat. Nos. 5,113,325, 5,128,843, and 5,375,044.

Referring now to FIG. 1, an example of a curtain light emitting system 100 from the prior art is shown. Light emitting system 100 includes light emitting elements 105 disposed within holes 113 of a substrate 111. Light emitting elements 105 are secured to attachment members 107, and attachment members 107 are then attached to substrate 111, generally by adhesive. Light emitting elements 105 further include electrical connectors 151 attached thereto such that power may be supplied to light emitting elements 105. After construction of light emitting system 100, though, any repair or replacement of light emitting elements 105 or the associated wiring may not be possible because of the adhesive attachment to substrate 111. Furthermore, it may be difficult to reconfigure the arrangement of light emitting elements 105 on substrate 111 after attachment.

Thus, there is a growing need for light emitting assemblies and systems that may allow for quick and easy repair or replacement of parts, even after initially installed and secured to a substrate. Such light emitting assemblies may removably attach to the substrate and may be incorporated into flexible, and non-flexible, applications.

### SUMMARY OF INVENTION

In one aspect, embodiments disclosed herein relate to a light emitting assembly configured to attach to a substrate. The assembly includes a female member, a male member having an optical portion, and a pixel disposed within the male member. The male member is configured to engage the female member such that the optical portion of the male member is viewable through the female member. Further, the male member and the female member are adapted to secure the substrate therebetween, and the pixel is configured to receive an electrical signal and power.

In another aspect, embodiments disclosed herein relate to another light emitting assembly. The assembly includes a female member, a male member, a pixel coupled to the male member, and a connection system attached to the male member and configured to supply an electrical signal and power to the pixel. The male member is configured to engage the female member such that the pixel is viewable through the female member, and the male member and the female member are adapted to secure a substrate therebetween.

In yet another aspect, embodiments disclosed herein relate to a light emitting system. The system includes a substrate, a wire, and a plurality of light emitting assemblies. Each of the plurality of light emitting assemblies includes a female member, a male member having an optical portion, a pixel disposed within the male member, and a connection system attached to the male member and configured to supply an electrical signal and power from the wire to the pixel. The male member is configured to engage the female member such that the optical portion of the male member is viewable through the female member, and such that the substrate is secured between the male member and the female member.

Further, in yet another aspect, embodiments disclosed herein relate to a method of securing a light emitting assembly to a substrate. The method includes providing a female member and a male member with a pixel coupled thereto, disposing the substrate between the male member and the female member, and engaging the male member with the female member such that the pixel is viewable through the female member and the substrate is secured therebetween.

Other aspects and advantages of the invention will be apparent from the following description and the appended claims.

### BRIEF DESCRIPTION OF DRAWINGS

FIG. 1 shows a cross-sectional view of a prior art light emitting assembly.

FIGS. 2A-2C show perspective views of a light emitting assembly in accordance with embodiments disclosed herein.

FIG. 3 shows a cross-sectional view of a light emitting assembly in accordance with embodiments disclosed herein.

FIGS. 4A-4C show perspective views of a light emitting assembly in accordance with embodiments disclosed herein.

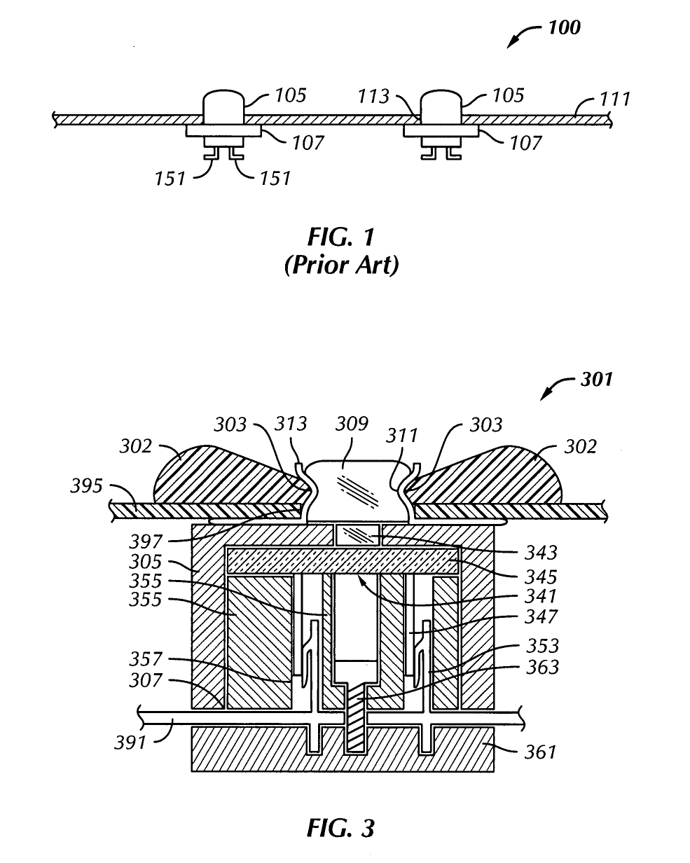

### DETAILED DESCRIPTION

Specific embodiments of the present invention will now be described in detail with reference to the accompanying figures. Like elements in the various figures may be denoted by like reference numerals for consistency.

In one aspect, embodiments disclosed herein relate to an improved light emitting assembly to attach pixels to a non-rigid substrate and have the pixels display an image or a video. In another aspect, embodiments disclosed herein relate to a light emitting assembly with engaging male and female members to secure and protect a substrate therebetween. In yet another aspect, embodiments disclosed herein relate to a light emitting assembly that enables removable engagement between a male member and a female member, thereby allowing simple assembly, disassembly, reconfiguration, or replacement of the light emitting assembly.

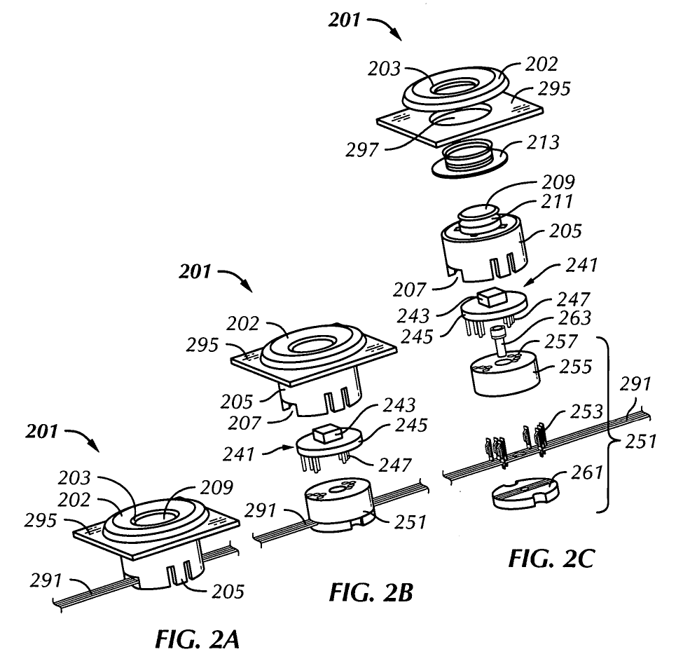

Referring to FIGS. 2A-2C, perspective views of a light emitting assembly 201 in accordance with embodiments disclosed herein are shown. Specifically, light emitting assembly 201 is shown as assembled in FIG. 2A, as partially-exploded in FIG. 2B, and as fully-exploded in FIG. 2C. Light emitting assembly 201 is configured to electrically connect to a wire 291 to supply an electrical signal and power thereto. Further, light emitting assembly 201 is configured to attach to a substrate 295, such as a substrate of a large-scale light emitting display system. As shown, light emitting assembly 201 includes a male member 205 and a female member 202, each configured to engage with one another. Male member 205 engages female member 202 through a hole 297 of substrate 295 (shown in FIG. 2C) such that light emitting assembly 201 is attached and secured to substrate 295.

Referring now to FIGS. 2B and 2C, light emitting assembly 201 includes a pixel 241 and a connection system 251. Pixel 241 is coupled to male member 205 such that when light emitting assembly 201 is fully assembled, light emitted from pixel 241 is viewable through female member 202 (discussed more below). In this embodiment, pixel 241 is coupled to male member 205 by disposing pixel 241 within male member 205. Male member 205 may have a bottom hole 207, for example, to position pixel 241 therein. However, in another embodiment, the pixel may be coupled to the male member of the light emitting assembly by disposing the pixel on the male member, such as disposing the pixel on the top end of the male member. Regardless, connection system 251 electrically connects to wire 291 to supply an electrical signal and power to pixel 241 coupled to male member 205.

Further, male member 205 may include an optical portion 209. Optical portion 209 is preferably manufactured from a material to allow light emitted from pixel 241 to pass through optical portion 209 and be seen by an outside viewer. Such manufacturing materials for the optical portion may include, but are not limited to, a transparent material, a translucent material, a diffusive material, a colored material, a refractive material, and a reflective material. Further, the optical portion may be separately manufactured and then attached to male member, as shown, or the optical portion and the male member may be manufactured together in a single component.

As discussed above, the male member and the female member of the light emitting assembly are configured to engage one another and secure a substrate therebetween. In FIGS. 2A-2C, male member 205 removably engages female member 202 with an interference fit. Specifically, in this embodiment, optical portion 209 of male member 205 enters through hole 297 of substrate 295 and a hole 203 of female member 202. Female member 202 may then be positioned over the top end of optical portion 209 and be retained in a groove 211 of optical portion 209. Preferably, the inner diameter of the hole of the female member is slightly smaller than the outer diameter of the optical portion of the male member. Thus, the female member may then be securely retained in the groove of the optical portion of the male member and be prevented from easily losing engagement because of the interference between the larger outside diameter of the male member and the smaller inside diameter of the female member. Further, a fitting sleeve 213 may be disposed between members 202 and 205 to provide a more secure engagement, if necessary. For example, fitting sleeve 213 may be disposed about optical portion 209 to have the outside diameter of optical portion 209 of male member 205 larger than the inner diameter of hole 203 of female member 202 to ensure a secure interference fit.

With this arrangement, the top end of the optical portion of the male member is viewable through the hole of the female member. As used herein, “viewable” refers to at least a portion of the optical portion and/or the pixel being capable of seen or viewed from an outside viewer. For example, as shown in FIG. 2A, the top end of optical portion 209 is viewable through hole 203 of female member 202 from side A. Thus, if optical portion 209 of male member 205 is manufactured from a transparent material and pixel 241 is disposed therein, light emitting from pixel 241 may pass through optical portion 209 and be seen by a viewer positioned at side A. Further, in another example, the optical portion of the male member may also include a hole or passage. As such, light emitting from the pixel disposed within the male member may pass through the hole or passage within the optical portion and be seen by a viewer.

Referring back to FIGS. 2B and 2C, pixel 241 may include a light emitting element 243 disposed on and electrically connected to a printed circuit board 245 (PCB). Pins 247 may then be attached to and extend from the bottom of PCB 245. In this arrangement, pins 247 may electrically connect to connection system 251 and supply an electrical signal and power from connection system 251 to pixel 241, thereby enabling control (e.g., selectively turning on and off) of pixel 241 with the electrical signal and power.

Further, connection system 251 may include electrical connectors 253, a housing 255, a back plate 261, and a fastener 263. As shown in FIG. 2C, electrical connectors 253 electrically connect with wire 291 and protrude outward to enable access for an electrical connection with pixel 241. The electrical connectors may be spring connectors, as shown, insulation displacement connectors, or any other electrical connectors known in the art. Further, the electrical connectors may be integrally formed with the wire, or the electrical connectors may be manufactured separately and then attached and electrically connected to the wire. Regardless, electrical connectors 253 that electrically connect with wire 291 may be disposed between housing 255 and back plate 261. Specifically, as shown, electrical connectors 253 may protrude and be disposed within holes 257 of housing 255. A back plate 261 may then be secured to housing 255 with, for example, a fastener 263 (e.g., screw, bolt), such that electrical connectors 253 are disposed between housing 255 and back plate 261. With this arrangement, pins 247, electrically connected to pixel 241, may extend into holes 257 of housing 255 and electrically connect with electrical connectors 253 to enable pixel 241 to receive an electrical signal and power through wire 291. As is known in the art, wire 291 may be connected to a source so as to control (e.g., selectively turn on and oft) pixel 241. Further, those having ordinary skill in the art will appreciate that a wire is described generically herein as the method of transmission of an electrical signal and power from a source to the light emitting assembly, but the present invention is not so limited and may include any method known in the art, such as by an Ethernet cable or by wireless communication.

Furthermore, as shown in FIGS. 2B and 2C, pixel 241 of the light emitting assembly 201 includes a single light emitting element 243. However, those having ordinary skill in the art will appreciate that the invention is not so limited, and in other embodiments the pixel may include multiple light emitting elements. These light emitting elements may then include, for example, light emitting diodes (LEDs), organic LEDs (OLEDs), polymer LEDs (PLEDs), incandescent lamps, or any other lighting elements known in the art. Therefore, in one embodiment, a pixel may include a plurality of LEDs such that light of a desired color may be emitted from each pixel. For example, the pixel may include a red LED, a blue LED, and a green LED such that the intensity of each LED may be varied to produce a desired color, as is well known in the art. Further, those having ordinary skill in the art will appreciate that the pixels may be of any size and shape, such as square or circular, and the size and shape need not be uniform throughout the use in a system having multiple light emitting assemblies of the present invention. Furthermore, the pixels may also include driver circuits that vary the intensities of the lighting elements within the pixel.

Using multiple light emitting assemblies attached to one or more substrates, a light emitting system may be manufactured for use in various industries. With each light emitting assembly of the system receiving an electrical signal and power, the system may be configured to display an image or a video. Preferably, the substrate is manufactured from a non-rigid material, such as a flexible material for use as a curtain and/or a theatrical backdrop. This non-rigid material may then include denim, polyester, vinyl, nylon, other plastic materials, or any other non-rigid material known in the art. However, those having ordinary skill in the art will appreciate that the invention is not so limited, and the substrates of the light emitting system may also be manufactured from a rigid material. Further, those having ordinary skill in the art will appreciate that the substrates of the light emitting system may be manufactured from a material that is transparent, translucent, colored, opaque, diffusive, pre-printed, or any other decorative material known in the art. For example, in one embodiment, the light emitting system may be retractable and portable, may present an attractive appearance both when dormant and when illuminated, and may easily integrate with a wide range of chosen backgrounds or architecture. Furthermore, preferably the female member of the light emitting assembly is manufactured of a same or similar material as the substrate so as to easily integrate with the substrate when assembled and in use. However, those having ordinary skill in the art will appreciate that the female member is not so limited, and may be formed of any material known in the art, decorative or not.

Referring now to FIG. 3, a cross-sectional view of a light emitting assembly 301 in accordance with embodiments disclosed herein is shown. As shown, light emitting assembly 301 is fully assembled having a male member 305 engaging a female member 302 with an interference fit such that an optical portion 309 of male member 305 is viewable through female member 302. Specifically, similar to the light emitting assembly of FIG. 2, optical portion 309 of male member 305 enters through a hole 397 of a substrate 395 and a hole 303 of female member 302. Inner diameter of hole 303 of female member 302 may then be slightly smaller than the other diameter of optical portion 309 of male member 305 such that female member 302 may be retained in a groove 311 of optical portion 309. Optical portion 309 is shown as attached to male member 305, however those having ordinary skill in the art will appreciate that optical portion 305 may instead be integrally formed with male member 305.

A pixel 341 is coupled to male member 305, in which, in this embodiment, pixel 341 is disposed within male member 305 through a bottom hole 307. Thus, if optical portion 309 is manufactured from a transparent material, light emitting from pixel 341 may then emit through optical portion 309 of male member 305 and be viewable. Pixel 341 includes a light emitting element 343 disposed on and electrically connected to a PCB 345 with pins 347 extending from the bottom of PCB 345. Pins 347 extend down into holes 357 of a housing 355 and electrically connect with electrical connectors 353 (also disposed within holes 357). Electrical connectors 353 are electrically connected to a wire 391 such that an electrical signal and power may be transmitted from wire 391 along to pixel 341.

Referring still to FIG. 3, a fastener 363 may be used to fasten together housing 355 and a back plate 361 to encompass and protect electrical connectors 353. However, those having ordinary skill in the art will appreciate that other fastening devices may be used to fasten together the housing and the back plate, such as having collets or fingers protruding from the housing to grasp and secure the back plate. Further, those having ordinary skill in the art will appreciate that the housing may altogether be excluded, and in another embodiment the back plate and the male member may then be secured together to protect the electrical connectors.

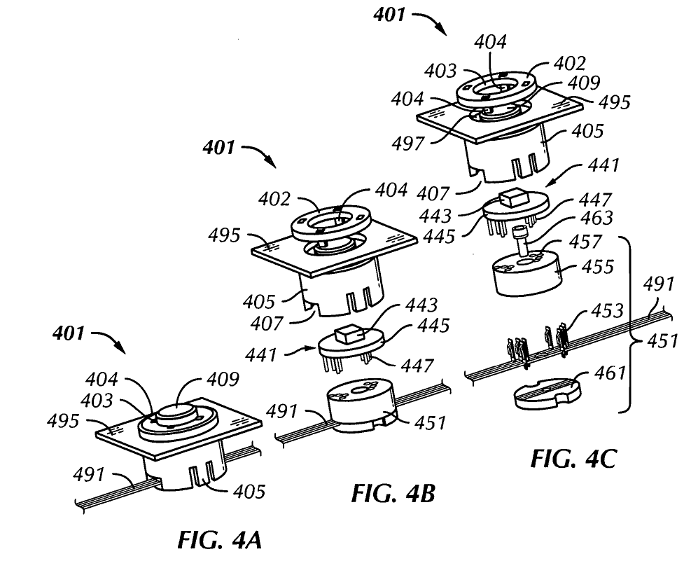

Referring to FIGS. 4A-4C, perspective views of a light emitting assembly 401 in accordance with embodiments disclosed herein are shown. Specifically light emitting assembly 401 is shown as assembled in FIG. 4A, as partially-exploded in FIG. 4B, and as fully-exploded in FIG. 4C. Light emitting assembly 401 is similar in construction to light emitting assembly 201 of FIGS. 2A-2C, however, in this embodiment, a female member 402 of light emitting assembly 401 includes fingers 404. Specifically, instead of using an interference fit between hole 203 of female member 202 and optical portion 209 of male member 205 as shown in FIGS. 2A-2C, an interference fit may be formed by fingers 404 of female member 402 extending into protrusions (not shown) of a male member 405 of light emitting assembly 401. Male member 405 may include protrusions therein such that fingers 404 may extend down and into male member 405 such that when inside male member 405, fingers 404 attach and engage male and female members 402 and 405 together. Thus, as is known in the art, the size and shape of fingers 404 may interfere with the protrusions of male member 405 such that members 402 and 405 are secured together, but, with sufficient force, fingers 404 may release and disengage members 402 and 405 from one another.

Further, those having ordinary skill in the art will appreciate that instead of using an interference fit to removably engage the male and female members of the light emitting assembly of the present invention together, such as the embodiments shown in FIGS. 2A-2C, 3, and 4A-4C, the male and female members may threadedly engage. For example, in one embodiment, if a male thread was formed on the male member and a female thread was formed on the female member of the light emitting assembly, the members may rotate with respect to one another to removably threadedly engage. Thus, the present invention is not only limited to interference fit between the male and female members of the light emitting assembly.

Embodiments of the present invention may provide for one or more of the following advantages. First, light emitting assemblies of the present invention may provide protection and support to substrates of light emitting systems to prevent the substrate from fraying or nipping. For example, with the male and female members securing the substrate therebetween, the members may encase the hole cut within the substrate for the light emitting assembly. Next, light emitting assemblies of the present invention may provide for removable engagement between the male and female members. This may allow for simple assembly, disassembly, reconfiguration, or replacement of part or all of the light emitting assembly of the present invention. Further, light emitting assemblies and systems of the present invention may be architecturally more useful and aesthetically more pleasing than typical display units having a more rigid structure. For example, light emitting systems may include a transparent material, in which the light emitting system may then blend into the backgrounds of their environment more easily. Furthermore still, display units of the present invention may provide for effective systems and displays while in use, such as displaying pre-recorded or live video, and may be transparent when not in use.

While the invention has been described with respect to a limited number of embodiments, those having ordinary skill in the art, having benefit of this disclosure, will appreciate that other embodiments may be devised which do not depart from the scope of the present invention as disclosed herein. Accordingly, the scope of the invention should only be limited by the attached claims.

What is claimed is:

1. A light emitting assembly configured to attach to a substrate, the assembly comprising:
a female member;
a male member having an optical portion;
a pixel disposed within the male member;
wherein the pixel is configured to receive an electrical signal and power;
wherein the male member is configured to engage the female member such that the
optical portion of the male member is viewable through the female member; and
wherein the male member and the female member are adapted to secure the substrate therebetween.

2. The assembly of claim 1, wherein the male member is configured to removably engage the female member with one of an interference fit and a threaded engagement.

3. The assembly of claim 1, further comprising a fitting sleeve disposed between the female member and the male member.

4. The assembly of claim 1, wherein the optical portion is attached to the male member.

5. The assembly of claim 1, wherein the optical portion comprises at least one of a transparent material, a translucent material, a diffusive material, a colored material, a refractive material, and a reflective material.

6. The assembly of claim 1, wherein the substrate comprises a non-rigid material.

7. The assembly of claim 1, wherein the pixel comprises a light emitting element disposed on and electrically connected to a printed circuit board.

8. The assembly of claim 7, wherein the light emitting element comprises a plurality of light emitting diodes of different colors.

9. A light emitting assembly, comprising:
a female member;
a male member;
a pixel coupled to the male member;
a connection system attached to the male member and configured to supply an electrical signal and power to the pixel;
wherein the male member is configured to engage the female member such that the pixel is viewable through the female member; and
wherein the male member and the female member are adapted to secure a substrate therebetween.

10. The assembly of claim 9, wherein the male member comprises an optical portion, wherein the pixel is viewable through the optical portion.

11. The assembly of claim 9, wherein the male member is configured to removably engage the female member with one of an interference fit and a threaded engagement.

12. The assembly of claim 9, wherein the connection system is adapted to electrically connect to a wire to supply the electrical signal and power to the pixel.

13. The assembly of claim 12, wherein the connection system comprises a housing secured to a back plate with an electrical connector disposed therebetween, and wherein the electrical connector is electrically connected to the wire.

14. The assembly of claim 13, wherein the electrical connector comprises at least one of a spring connector and an insulation displacement connector.

15. The assembly of claim 13, wherein the pixel comprises a light emitting element disposed on and electrically connected to a printed circuit board, and wherein pins attached to the printed circuit board electrically connect with the electrical connector.

16. A light emitting system, comprising:
a substrate;
a wire; and
a plurality of light emitting assemblies, wherein each of the plurality of light emitting assemblies comprises:
a female member;
a male member having an optical portion;
a pixel disposed within the male member;
a connection system attached to the male member and configured to supply an electrical signal and power from the wire to the pixel;
wherein the male member is configured to engage the female member such that the optical portion of the male member is viewable through the female member, and such that the substrate is secured between the male member and the female member.

17. The system of claim 16, wherein the male member a first light emitting assembly is configured to removably engage the female member of the first light emitting assembly with at least one of an interference fit and a threaded engagement.

18. The system of claim 16, wherein the substrate comprises at least one of a transparent material, a translucent material, a diffusive material, a colored material, an opaque material, and a pre-printed material.

19. A method of securing light emitting assembly to a substrate, comprising:
providing a female member and a male member with a pixel coupled thereto;
disposing the substrate between the male member and the female member; and
engaging the male member with the female member such that the pixel is viewable through the female member and the substrate is secured therebetween.

20. The method of claim 19, wherein the male member is removably engaged with the female member with one of an interference fit and a threaded engagement.
